(19) United States
(12) Patent Application Publication
(10) Pub. No.: US 2023/0373521 A1
(43) Pub. Date: Nov. 23, 2023

(54) SYSTEM FOR AUTOMATICALLY OPERABLE VEHICLES FOR THE PERCEPTION OF ROAD DAMAGES

(71) Applicant: ZF Friedrichshafen AG, Friedrichshafen (DE)

(72) Inventors: Michael HERTKORN, Bodolz (DE); Jens GIESLER, Friedrichshafen (DE)

(73) Assignee: ZF Friedrichshafen AG, Friedrichshafen (DE)

(21) Appl. No.: 18/319,280

(22) Filed: May 17, 2023

(30) Foreign Application Priority Data
May 17, 2022 (DE) 10 2022 204 831.8

(51) Int. Cl. B60W 60/00; B60W 50/02; E01C 23/01

(52) U.S. Cl. CPC B60W 60/001; B60W 50/0205; E01C 23/01; B60W 2420/42; B60W 2552/53; B60W 2756/10

(57) ABSTRACT

A system with which automated vehicles can detect road damage, wherein the automated vehicles have at least one sensor for detecting structure-borne and/or air-borne sounds generated by the vehicle when driving over road damage, wherein the system is configured to detect the road damage on the basis of the data from the at least one sensor. The system also records the position of the automated vehicle when driving over the road damage and stores it. Position and information regarding the road damage are sent to a control unit in the automated vehicle, or other automated vehicles. The control unit determines regulating and/or control signals for an avoidance trajectory with which the road damage is avoided or passed on the basis of the position and information regarding the road damage that is received.

### CROSS-REFERENCE TO RELATED APPLICATION

This application claims priority to German Application No. 10 2022 204 831.8, filed on May 17, 2022, the entirety of which is hereby fully incorporated by reference herein.

### BACKGROUND AND SUMMARY

The invention relates to a system with which automated vehicles can detect road damage.

The following definitions, descriptions, and explanations relate to and can be applied to the entirety of the invention disclosed herein.

An automated vehicle is a vehicle such as a passenger automobile, truck, bus or transportation system for goods or people, e.g. a shuttle, that has a technological system, e.g. environment sensors such as radar, cameras, lidar, microphones, and/or scent sensors, electronic control units, and/or actuators, which help a driver operate a vehicle, e.g. with regard to the longitudinal and/or guidance thereof (SAE levels 0 to 3), or control the vehicle without human intervention (SAE levels 4 to 5). Automated driving functions are driving functions for longitudinal and/or lateral guidance, e.g. acceleration in the form of braking or turning, and driving functions for communicating with the environment, e.g. operating lights such as headlamps or signal lights, or operating sound devices such as the horn. Another example of automated vehicles in the field of application for the invention relates to automatically guided vehicles for material transportation, e.g. assembly line towing vehicles or tractor units for use in airports or harbors, without a cabin for the driver.

Automated rail-borne transport systems for people, e.g. Personal Rapid Transit, are known from the prior art. By way of example, EP 2 360 544 B1 discloses a system for determining the position of a vehicle that uses numerous individual magnetic markers placed in a surface on which the vehicle can travel, in which the system contains numerous sensors for measuring the magnetic field strengths of the individual magnetic markers.

U.S. Pat. No. 5,347,456 A discloses a reference system with which a vehicle can be located on a roadway using magnetic markers.

DE 10 2019 215 658 B3 discloses a system for monitoring automated driving functions in an automated vehicle. The system comprises numerous markers placed in a road surface, numerous sensors placed on the vehicle, which measure the field strengths of the individual markers, and a computer that determines the positions of the sensors on the basis of the field strengths measured therewith, and determines the position of the vehicle in relation to the markers on the basis of the positions of the sensors. The system also comprises a control unit for automated driving. The computer monitors the trajectory of the vehicle determined by the control unit on the basis of the signals from environment detection sensors in the vehicle during the automated operation thereof based on the position of the vehicle in relation to the markers and vehicle data, and overrides or deactivates the system if the control signals from the control unit for actuators for the longitudinal and/or lateral guidance of the vehicle deviate from the determined trajectory.

Methods and apparatuses are also known from the prior art for an acoustic assessment of a motor vehicle. By way of example, DE 10 2007 051 261 A1 discloses an apparatus comprising a microphone, with which acoustic signals in the motor vehicle can be detected. An evaluation unit determines features in these signals and classifies them on the basis of a reference classification.

Road damage relates to the state of the road surface, e.g. damage to mortar or binder in the road surface, so-called surface fatigue, resulting in the loosening of chunks of the pavement, referred to as crocodile or alligator cracking. Another example is the accumulation of bituminous binder on the road surface caused by heavy traffic. Other examples of road damage are bulges or cracks caused by frost heaves, resulting in potholes. Besides having a negative impact on the basic fabric of the road surface, road damage also has a negative impact on the traffic, e.g. resulting in damage to various parts of the vehicle, e.g. the tires, chassis, and/or suspension.

Road damage detection is typically carried out in the prior art through mapping with extremely precise sensor technology in a reference vehicle. The collected data is subsequently used to locate the vehicle using lidar and radar data. Road damage can be noted in these maps and thus avoided. The mapping is not continuously updated, however, such that recent road damage may not yet be detected.

Automated vehicles, e.g. self-driving vehicles such as autonomous transport systems for people, such as people movers or shuttles, often travel the same routes on public roads or internally managed areas. If there is any road damage, e.g. a pothole, the self-driving vehicle will constantly driver over it, which may result in damage to the self-driving vehicle over time, and discomfort for the passengers. This is particularly the case with segregated lane shuttles, which can remain precisely in their lanes because of small magnets in the road. A human driver would remember a pothole after driving over it, and be able to avoid it in the future by altering the trajectory of the vehicle.

Road damage is not always effectively detected with cameras and radar systems for identifying obstacles. Radar can identify an obstacle that has a notable depth. Road damage does not necessarily have to be of a notable depth, however. Consequently, it is difficult to impossible to detect road damage with radar. Camera-based object detection algorithms have difficulty distinguishing between road damage and puddles or surfaces that have been painted, because the abrupt vertical change in the surface that distinguishes road damage is quite small in the camera image and therefore difficult to notice.

A fundamental object of the invention is better detection of road damage.

The subject matter disclosed herein solves this problem. Advantageous embodiments of the invention can be derived from the definitions, dependent claims, drawings, and the descriptions of preferred exemplary embodiments.

The invention results in a system with which automated vehicles can detect road damage. The automated vehicles have at least one sensor for detecting structure-born sounds resulting from driving over road damage and/or at least one sensor for detecting air-born sounds resulting from driving over road damage. The system is configured to
detect road damage on the basis of data from the at least one sensor for detecting structure-borne sound and/or at least one sensor for detecting air-born sound;
record the position of the automated vehicle when driving over the road damage, and store this with the data regarding the detected road damage as the position of the road damage;
send the position and data regarding the road damage to a control unit in the automated vehicle, or other automated vehicles, before the next time the vehicle, or another automated vehicle, drives over the road damage.

The control unit determines regulating and/or control signals for an avoidance trajectory, with which the road damage is avoided or passed, on the basis of the position and information regarding the road damage that it receives. This or the other automated vehicle follows the avoidance trajectory.

The vehicle can be an autonomous transport system for people, or a shuttle, for example, that is used in public transportation, e.g. potentially in segregated lanes. The vehicle vibrates when travelling over road damage, which is detected by structure-borne sensors in the vehicle. The sensor for detecting structure-borne sounds can be an acceleration sensor or piezo element. The road damage can also be detected acoustically, which has advantages when the amplitudes of the structure-borne sounds are relatively small, e.g. when travelling over rough surfaces. The sensor for detecting air-borne sounds detects fluctuations in acoustic pressure, for example. The sensor for detecting air-borne sounds can be an acoustic pressure sensor, e.g. a microphone or an array of microphones.

The position can be recorded as a GPS position, for example. It is also possible for the data to indicate which tire or tires on the vehicle passed over the road damage.

The next time the vehicle passes over this position, i.e. the position where the road damage has been detected, the self-driving vehicle can easily adjust its trajectory on the road, e.g. with a deviation of 5 cm to the left, in an attempt to avoid the road damage in question. The self-driving vehicle does not have to be the first self-driving vehicle, and instead can be another vehicle from the same fleet, which then selects a slightly different trajectory at the position in question, in order to avoid the road damage.

According to another aspect of the invention, a threshold value is defined for the number of times a position in question must be driven over until an avoidance maneuver is introduced, e.g. greater than one. This reduces the effect of false-positive predictions.

The control unit is an autonomous driving domain ECU, for example, for controlling automated driving, e.g. driverless, fully automated or autonomous driving. The autonomous driving domain comprises environment detection sensors, the signals of which are processed by the domain ECU, and provided to the drive, steering and braking systems in the form of control signals for autonomous regulation and control of the longitudinal and/or lateral guidance of the vehicle. The control unit can comprise a multi-core processor and memory modules, for example. The multi-core processor is configured for signal and data exchange with memory modules. The multi-core processor can comprise a bus system, for example. The memory modules form the computer memory. The memory modules can be in the form of RAM, DRAM, SDRAM, or SRAM. The control unit comprises at least one central processing unit, according to one aspect of the invention. The control unit can also comprise at least one graphics processing unit. According to one aspect of the invention, the graphics processing unit comprises at least one processing unit that is designed specifically for tensor and/or matrix multiplication. Tensor and/or matrix multiplications are central computing operations for machine learning. The control unit is connected through interfaces for signal transfer to vehicle actuators, e.g. brake actuators.

According to another aspect of the invention, the system is configured to record the regulating and/or control signals for the avoidance trajectory if the system does not detect any road damage when following the avoidance trajectory from this or another automated vehicle, and then provide the regulating and/or control signals to other automated vehicles. If the road damage detection no longer detects any road damage when travelling the same route with the avoidance trajectory, this avoidance trajectory can be stored and shared with a vehicle fleet so that other vehicles can avoid the road damage with the same avoidance trajectory.

According to another aspect of the invention, the automated vehicles each have at least one imaging sensor for recording an image of the road damage. The system is configured to send the data from the at least one imaging sensor to a public easement administrator in order for the public easement administrator to be able to eliminate the road damage, and/or send the data to a geographic data service in order to mark the road damage in map updates.

The imaging sensor can be a camera sensor, for example, and the image can be a photograph. The public easement administrator can be a city administrator, for example. A geographic data service can be an online map provider, for example.

According to another aspect of the invention, the images, e.g. the photographs, are first analyzed by employees of a vehicle fleet before they are sent to the public easement administrator.

According to another aspect of the invention, the system comprises numerous markers placed in a road surface. The automated vehicles each contain at least one sensor for detecting the field strengths of the individual markers. The system is configured to determine the position of the respective automated vehicle in relation to the markers on the basis of the field strengths measured by the sensors.

The markers exert a force on test elements located within the magnetic fields of the individual markers, e.g. a spatial and temporal distribution of physical values. The markers can be needles placed in a road surface such as asphalt, for example. The road surface can be the surface of a freeway, highway, county road, or city street. By way of example, the markers can be placed along the road markings, e.g. the lane lines or shoulder markings, bike lanes, or pedestrian crosswalks.

The sensors for detecting the field strengths comprise the test elements and are placed over the width of the vehicle, e.g. in a sensor array that can comprise numerous sensors, e.g. 25 to 100 sensors. The sensors can be placed on the undersurface of the vehicle or in the front bumper, such that they are at a height of 30 cm above the road surface. The sensors can function at a frequency of 20 kHz to 1 MHz, for example. According to one aspect of the invention, the frequency depends on the state of the vehicle, e.g. the speed at which the vehicle is travelling.

The markers can be permanent magnets, for example, such as anisotropic ferrite magnets in the form of magnetic needles. The magnetic fields of these magnets are described in: https://www.researchgate.net/profile/Carsten_Markgraf/publication/33959284_Autonom Au_Fahren_mit_Hilfe_der_Magnetnageltechnik_Elektronische_Ressource/links/00b7d5 52ddf2a30264000000/Autonomes-Fahren-mit-Hilfe-der-Magnetnageltechnik-Elektronische-Ressource.pdf, chapter 2.1, which is included hereby in the subject matter of this application. The sensors that detect the magnetic field strengths can be magnetic sensors. GMR technology (Giant Magnetoresistance) can play a role in the magnetic sensors. The measuring cell is composed of resistors comprising numerous thin ferromagnetic and non-magnetic layers. If two GMR resistors are used in a classic Wheatstone bridge, a large signal is obtained in the presence of a magnetic field that is proportional to the magnetic field. At a defined threshold value, an output signal is issued from a comparator.

The system can monitor a trajectory of the vehicle determined by the control unit on the basis of signals from environment sensors in the vehicle based on the position of the vehicle in relation to the markers and vehicle data during the automated operation thereof. This results in a magnetic guidance.

The markers that guide the vehicle, e.g. the magnetic needles, ensure that the vehicle will travel precisely along the same path every time. This increases the precision in locating road damage in relation to GPS coordinates. The road can thus be scanned more precisely. The communication with the other automated vehicles, e.g. in a vehicle fleet, has the further advantage that all of the vehicles have the same magnetic guidance, and therefore travel along the exact same path.

Another aspect of the invention relates to the encoding of legal regulating systems regarding the polarities of magnets. If a magnet placed in the road surface with the north pole pointing upward represents a 0, and a magnet placed in the road surface with the south pole pointing upward represents a 1, various encoding processes can be used based on the positions of the magnets. Examples of encoding processes are disclosed in EP 1 436 187 B1, paragraphs [0029] to [0032], and are hereby included in the disclosure of this patent application.

According to another aspect of the invention, the automated vehicles comprise
a memory in which the position of the road damage and the information regarding the detected road damage are stored locally; and
a vehicle communication unit that sends and/or receives the position and information regarding the detected road damage.

The vehicle communication unit is based on vehicle-to-vehicle communication (V2V communication) or vehicle-to-everything communication (V2X communication). By way of example, the vehicle communication unit is a V2V or V2X domain ECU.

According to another aspect of the invention, the system comprises a cloud memory. The system is configured for cloud computing. The automated vehicles each comprise a vehicle communication unit that sends the data from the at least one sensor in the respective automated vehicle and/or the position and information regarding the detected road damage to the cloud memory, and/or receives the position and information regarding the detected road damage from the cloud memory.

The system can be a distributed system in this manner, e.g. a cloudified system. The detection of the road damage can take place in the cloud, for example. According to one aspect of the invention, the sensors comprise internet of things technology, and send their data to the cloud memory. The cloud infrastructure in the system can be a public, private, or hybrid cloud infrastructure.

According to another aspect of the invention, the system is configured to classify the road damage on the basis of sound, using data from the at least one sensor for detecting air-borne sound. The system is configured to obtain a mel spectrogram or extract mel-frequency cepstral coefficients based on the data from the sensor for detecting air-borne sound, process the mel spectrogram or the mel-frequency cepstral coefficients with a machine learning model that is trained to deduce what the road damage is from the mel spectrograms or mel-frequency cepstral coefficients entered in the machine learning model, which causes the sounds that are the basis for the mel spectrograms or mel-frequency cepstral coefficients.

This enables a targeted classification of the sounds, and therefore the road damage. The raw data are condensed through the acoustic processing of the raw data from the sensors for detecting air-borne sounds. The machine learning model can be a convolutional neural network or an artificial recurrent neural network, e.g. a recurrent convolutional network.

The mel-frequency cepstral coefficients, MFCC, can be extracted using open source libraries, e.g. the python_speech_features library, or the python librosa library.

According to another aspect of the invention, the system is configured to detect anomalies in the data from the at least one sensor for detecting air-borne sounds. The system is configured to process the data on the basis of mel spectrograms, fast Fourier transforms, or mel-frequency cepstral coefficients, and compare the processed data with similarly processed data from known traffic situations. The system is configured to execute an outlier detection algorithm in order to identify anomalies in the data.

The known traffic situations can be traffic situations with similarly detected data, e.g. with similar GPS coordinates, vehicle speeds, and/or accelerations. The outlier detection algorithm can be a density-based spatial clustering of applications with noise algorithm (DBSCAN algorithm).

### BRIEF DESCRIPTION OF THE DRAWING

FIG. 1 shows a block diagram of an automated vehicle in accordance with various embodiments.

### DETAILED DESCRIPTION

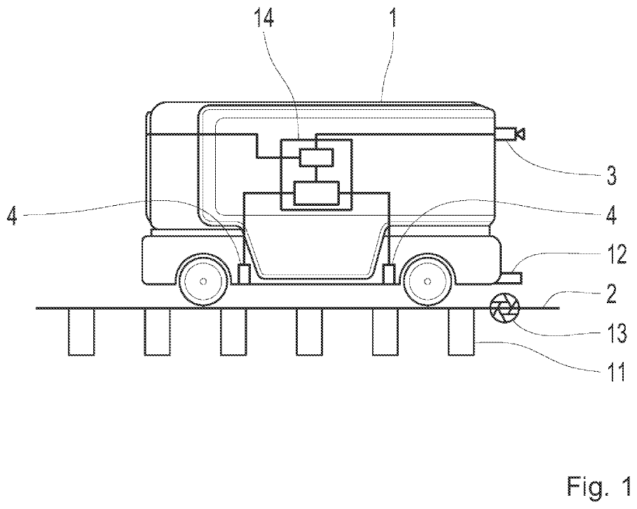

The invention shall be explained below in reference to FIG. 1. The automated vehicle 1 is an autonomous shuttle, by way of example. Markers 11, e.g. magnetic needles, are placed in a road surface 2, along and parallel to the traffic lines in the middle of the road, by way of example.

The magnetic field strengths of the individual markers 11 and potentially a resulting field strength of numerous field strengths from the individual markers 11 is measured with sensors 12, e.g. magnetic sensors. The sensors 12 are arranged in a sensor array, by way of example. The sensors 12 or the sensor array can be placed on a vehicle 1.

The signals from the sensors 12 are evaluated by a control unit 14. The control unit 14 then determines the position of the vehicle 1 in relation to the markers 11 and monitors a trajectory planning with regard to avoiding the road damage 13. The road damage 13 is a pothole, by way of example. The control unit 14 is connected with output interfaces to actuators 4 for automated driving functions, e.g. braking actuators.

The vehicle 1 comprises a microphone 3 and/or a structure-borne sound sensor 3 for detecting the road damage 13 when passing over it.

### REFERENCE SYMBOLS

1 vehicle
2 road surface
3 sensor
4 actuator
11 marker
12 sensor
13 road damage
14 control unit

1. A system for detecting road damage for an automated vehicle, comprising:
at least one sensor configured to detect structure-borne sounds generated by the vehicle when driving over road damage; and/or
at least one sensor configured to detect air-borne sounds when driving over road dam age,
wherein the system is configured to:
detect the road damage on a basis of data from the at least one sensor for detecting structure-borne sounds and/or the at least one sensor for detecting air-borne sounds;
record a position of the automated vehicle when driving over the road damage and store the position with data regarding the detected road damage as a position of the road damage; and
send the position and the data regarding the road damage to a control unit in the automated vehicle, or another automated vehicle, before a next time the automated vehicle, or the other automated vehicle, drives over the road damage;
wherein the control unit is configured to determine regulating and/or control signals for an avoidance trajectory, with which the road damage is avoided or passed, on a basis of the position and the data regarding the road damage that it receives, and wherein the automated vehicle or the other automated vehicle follows the avoidance trajectory.

2. The system according to claim 1, configured to:
record the regulating and/or control signals for the avoidance trajectory in response to the system not detecting any road damage when following the avoidance trajectory; and
provide the regulating and/or control signals to other automated vehicles.

3. The system according to claim 1, wherein the automated vehicle comprises:
at least one imaging sensor for recording an image of the road damage, and wherein the system is configured to:
send data from the at least one imaging sensor with which an image of the road damage is recorded to a public easement administrator in order to eliminate the road damage, and/or send the data to a geographic data service in order to mark the road damage in a map.

4. The system according to claim 1,
wherein a plurality of markers are included in a road surface,
wherein the automated vehicle has at least one sensor configured to detect field strengths of the individual markers, and
wherein the system is configured to:
record positions of the automated vehicle in relation to the plurality of markers on a basis of the field strengths measured by the at least one sensor configured to detect the field strengths.

5. The system according to claim 1, wherein the automated vehicle comprises:
a memory in which the position of the road damage and the data regarding the detected road damage are stored locally; and
a vehicle communication unit configured to send and/or receive the position and data regarding the detected road damage.

6. The system according to claim 1, comprising:
a cloud memory, wherein the system is configured for cloud computing,
wherein the automated vehicle comprises:
a vehicle communication unit that sends the data from the at least one sensor in the automated vehicle and/or the position and information regarding the detected road damage to the cloud memory, and/or receives the position and information regarding the detected road damage from the cloud memory.

7. The system according to claim 1, wherein the system is configured to:
classify the road damage on a basis of sound from the data obtained from the at least one sensor for detecting air-borne sounds;
obtain a mel spectrogram or extract mel-frequency cepstral coefficients from the data from the at least one sensor for detecting air-borne sound;
process the mel spectrogram or mel-frequency cepstral coefficients with a machine learning model that is trained to deduce what the road damage is from the mel spectrograms or mel-frequency cepstral coefficients entered in the machine learning model, which causes the sounds that are the basis for the mel spectrograms or mel-frequency cepstral coefficients.

8. The system according to claim 1, wherein the system is configured to:
detect anomalies in the data from the at least one sensor for detecting air-borne sounds;
process the data on a basis of mel spectrograms, fast Fourier transforms, or mel-frequency cepstral coefficients; and
compare the processed data with similarly processed data from known traffic situations;
and carry out an outlier detection algorithm to identify anomalies in the data.
